(19) United States
(12) Patent Application Publication
(10) Pub. No.: US 2017/0274747 A1
(43) Pub. Date: Sep. 28, 2017

(54) VEHICLE SOFT TOP STORAGE SYSTEM

(71) Applicants: Brice A Burkhardt, Lake Orion, MI (US); David W Pennala, Howell, MI (US); Jason E Schultz, Clarkston, MI (US)

(72) Inventors: Brice A Burkhardt, Lake Orion, MI (US); David W Pennala, Howell, MI (US); Jason E Schultz, Clarkston, MI (US)

(21) Appl. No.: 15/079,571

(22) Filed: Mar. 24, 2016

(51) Int. Cl. B60J 7/20; A45C 5/14; B60J 7/12

(52) U.S. Cl. CPC B60J 7/201; B60J 7/1291; A45C 5/14

(57) ABSTRACT

A storage system for a removable soft top assembly of a vehicle includes a main storage container having a top lid coupleable to a bottom lid, where the main storage container is sized and shaped to receive and store an articulating frame and main cover of the soft top assembly; a first supplemental storage container having a top lid coupleable to a bottom lid, the first supplemental storage container sized and shaped to receive and store windows of the soft stop assembly; and a second supplemental storage container having a top lid coupleable to a bottom lid, where the second supplemental storage container is sized and shaped to receive and store door rails of the soft top assembly. The second supplemental storage container is selectively coupleable to the first supplemental storage, and the first and second supplemental storage containers are selectively coupleable to the main storage container.

### FIELD

The present application relates generally to vehicle component storage systems and, more particularly, to a storage system for a removable soft top of a vehicle.

### BACKGROUND

It is known in the motor vehicle art to provide a convertible top, which may be folded back or removed from the vehicle. In one example, the convertible top is constructed of a flexible fabric (referred to as a soft top) and can be folded back to a storage position or otherwise removed from an installed position. Soft tops provide a user with the benefit of open air driving while affording available protection in the event of adverse weather conditions. Most known soft tops are designed to be easily retracted to a stored position, either under a source of power or manually. However, once removed from the vehicle, improper and/or unprotected storage of the soft top may cause damage or unnecessary wear thereto. Moreover, it may be difficult to compactly arrange the soft top and all its components for easy transport within the vehicle or to a storage location. Accordingly, while known soft top systems work for their intended purpose, it is desirable to provide an improved, user-friendly soft top storage system.

### SUMMARY

In accordance with an exemplary aspect of the invention, a storage system for a removable soft top assembly for a vehicle is provided. The storage system includes, in one exemplary implementation, a main storage container having a top lid coupleable to a bottom lid, the main storage container sized and shaped to receive and store an articulating frame and main cover of the soft top assembly, a first supplemental storage container having a top lid coupleable to a bottom lid, the first supplemental storage container sized and shaped to receive and store windows of the soft stop assembly, and a second supplemental storage container having a top lid coupleable to a bottom lid, the second supplemental storage container sized and shaped to receive and store door rails of the soft top assembly. The second supplemental storage container is selectively coupleable to the first supplemental storage, and the first and second supplemental storage containers are selectively coupleable to the main storage container.

In accordance with another exemplary aspect of the invention, a vehicle is provided. The vehicle includes, in one exemplary implementation, a rear cargo area, and a soft top assembly removably coupled to the vehicle, the soft top assembly having an articulating frame, a main cover, windows, and door rails. A soft top storage system is configured to removably couple to the rear cargo area, the soft top storage system configured to receive and store the articulating frame, the main cover, the windows, and the door rails.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a top perspective view of an exemplary vehicle with a partial cut-away view of a soft top assembly in an operative position in accordance with the principles of the present disclosure;

FIG. 2 is a rear view of an exemplary vehicle with the soft top assembly removed and an example soft top storage system stowed therein in accordance with the principles of the present disclosure;

FIG. 3 is a partial perspective view of the vehicle shown in FIG. 2 in accordance with the principles of the present disclosure;

FIG. 4 is a partial perspective view of the soft top storage system shown in FIG. 3 with portions of the soft top assembly stowed therein in accordance with the principles of the present disclosure;

FIG. 5 is a perspective view of an example main storage container of the soft top storage system shown in FIGS. 2-4 in a closed position in accordance with the principles of the present disclosure;

FIG. 6 is a perspective view of the main storage container shown in FIG. 5 in an open position in accordance with the principles of the present disclosure;

FIG. 7 is a perspective view of example first and second supplemental storage containers of the soft top storage system shown in FIGS. 2-4 in closed positions in accordance with the principles of the present disclosure;

FIG. 8 is a perspective view of the first and second supplemental storage containers shown in FIG. 7 in open positions in accordance with the principles of the present disclosure;

FIG. 9 is a perspective view of an example locking latch that may be used with the soft top storage system shown in FIGS. 2-8, in an unlatched position; and

FIG. 10 is a perspective view of the locking latch shown in FIG. 9 in a latched position.

### DESCRIPTION

As briefly discussed above, some motor vehicles include a soft top assembly that may be folded back into a stowed position or removed from the vehicle. Once removed, the soft top assembly may be subject to damage or wear if not properly stored.

Described herein is a storage system for a soft top assembly of a vehicle. The storage system is a rigid container system stowable within the vehicle and includes two smaller rigid storage containers configured to removably couple to a main rigid storage container. The main rigid container is configured to store a soft top frame and cover, and the two smaller rigid storage containers are configured to respectively store vehicle soft top windows and soft top door rails.

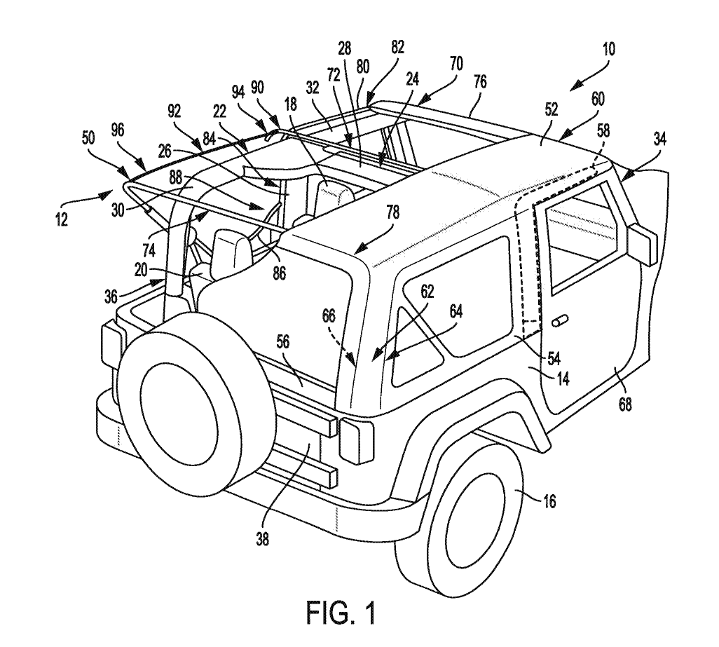

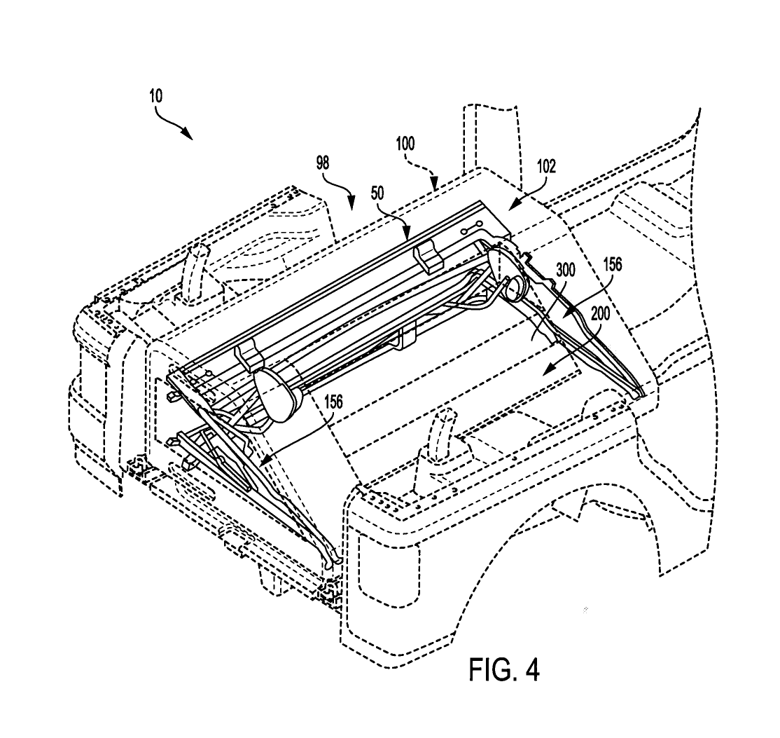

With initial reference to FIG. 1, an exemplary vehicle is shown and generally identified at reference numeral 10. The vehicle 10 includes a soft top assembly 12 illustrated in a deployed position to protect passengers in the vehicle interior from weather conditions such as wind, rain, or snow. The soft top assembly 12 can be articulated between its deployed position (FIG. 1) and a stored position, similar to the position shown in FIG. 4.

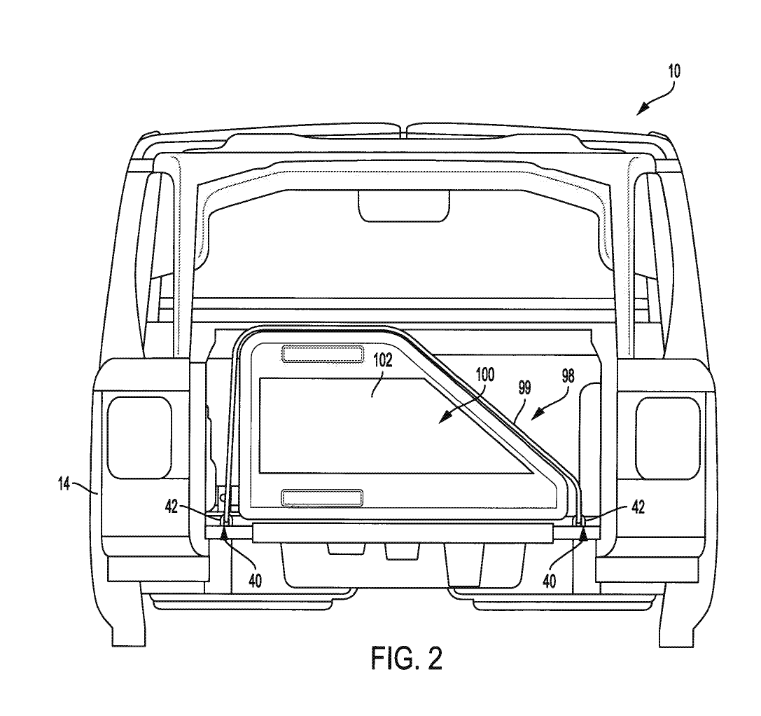

In the example implementation, the vehicle 10 generally includes a vehicle body 14, vehicle road wheels 16, front passenger seating 18, and rear passenger seating 20. A roll bar assembly 22 extends upwardly from the vehicle body 14 and includes generally U-shaped main roll bar 24 formed by a pair of laterally spaced apart vertical members 26 interconnected by a transverse member 28. A pair of rear roll bars 30 are coupled to the main roll bar 24 and extend rearward therefrom and downwardly to the vehicle body 14. A pair of side bars 32 are coupled to the main roll bar 24 and extend forwardly to a vehicle windshield assembly 34. As illustrated, portions of the roll bar assembly 22 may be covered with a protective padding 36. Although the vehicle 10 and roll bar assembly 22 are illustrated in FIG. 1 as a two-door configuration, the vehicle may be arranged in other configurations such as a four-door configuration, which is shown in FIGS. 2-4. It will be understood that the soft top assembly for the four door configuration may include some additional components, but is otherwise generally similar to the soft top assembly 12 described herein.

The illustrated soft top assembly 12 is coupled to the vehicle 10 and is configured articulate between the deployed position (FIG. 1) where it substantially covers the roll bar assembly 22 and the vehicle interior, and the stowed position where it is folded down upon itself and generally located at a rear of the vehicle 10 generally between a rear seat 20 and a tailgate 38. Further, the soft top assembly 12 may be removed from the vehicle 10 and subsequently stored in a soft top storage system 100, as is described herein in more detail. The soft top storage system may then be stored in a rear cargo area 98 of the vehicle, as shown in FIGS. 2-4, or in the two-door configuration when rear seat 20 is folded or removed.

In the illustrated example of FIG. 1, the soft top assembly 12 generally includes an articulating frame 50, a roof or main cover 52, a pair of removable quarter windows 54 (only one shown), a removable rear window 56, and door rails 58 (only one shown). The main cover 52 is coupled to and extends over the articulating frame 50. The main cover 52 includes a forward edge 60 configured to releasably couple to the windshield assembly 34, and a pair of rear sail panels 62 configured to releasably couple to the rear of the vehicle body 14.

The quarter windows 54 are removably coupled to the main cover 52, for example, by a zipper 64 and/or other attachment feature (e.g., hook and pile, button snap, strap, etc.). The quarter windows 54 are also removably coupled to the vehicle body 14 and the door rail 58. The rear window 56 is removably coupled to the main cover 52, for example, by a zipper 66 and/or other attachment feature (e.g., hook and pile, button snap, strap, etc.). The rear window 56 is also removably coupled to the vehicle body 14 and the vehicle tailgate 38. The door rails 58 are configured to provide a sealing face for a vehicle door 68 and are coupled proximate to the vehicle body 14 and portions of the roll bar assembly 22 such as, for example, vertical member 26 and/or side bar 32.

In the illustrated example, the articulating frame 50 generally includes a forward support member or bow 70, an intermediate support member or bow 72, and a rearward support member or bow 74. The forward bow 70 includes a header portion 76 coupled to the forward edge 60 of the soft top main cover 52. In the deployed position, the intermediate bow 72 extends transversely across the underside of the main cover 52 for supporting the fabric of the soft top main cover 52 in a cross-car direction. In the deployed position, the rearward bow 74 supports an upper rear edge 78 of the main cover 52.

The forward bow 70 is coupled to the roll bar assembly 22 for rotation about a first transverse pivot axis through a pair of side support members or bows 80. The side bows 80 are each generally L-shaped having a first end 82 coupled to the forward bow 70 and a second end 84 pivotally coupled to the main roll bar 24.

The rearward bow 74 extends transversely and is captured in the upper rear edge 78 of the soft top main cover 52. The rearward bow 74 includes laterally spaced L-shaped portions 86 pivotally coupled to the roll bar assembly 22 for rotation about a second transverse pivot axis. Each L-shaped portion 86 includes an end 88 pivotally coupled to the main roll bar 24.

The intermediate bow 72 includes ends 90 which are each supported by one side bow 80 when the soft top assembly is in the deployed position. A pair of tension straps 92 (only one shown) include a first end 94 coupled to the intermediate bow end 90, and a second end 96 attached to the rearward bow 74. As such, the tension straps 92 cooperate to draw the soft top taut in longitudinal direction when the soft top assembly 12 is in the deployed position.

When the soft top assembly 12 is articulated from its stored position to the deployed position (FIG. 1), the side bows 80 carry the forward bow 70 and the intermediate bow 72 through corresponding pivoting arcs from a cavity located between the rear seat 20 and the tailgate 38 to a top of the windshield assembly 34. At the same time, rearward bow 74 pivots about the second transverse pivot axis and the L-shaped portions 86 rest upon top of rear wheel house panels (not shown). As the side bows 80 articulate forward, the intermediate bow 72 pivots on the side bows 80 to clear the rear roll bars 30. The intermediate bow 72 comes to rest on the top of the L-shaped portions 86, and the side bows 80 and the forward bow 70 come to rest on top of the intermediate bow 72.

In the stored position, the soft top main cover 52 is folded backward upon itself and is attached to the forward bow 70, the intermediate bow 72, and the rearward bow 74, to thereby form a minimally visible stack, for example, similar to that shown in FIG. 4. A wrap or boot (not shown) may be used to gather loose fabric and retain the soft top assembly 12 in its collapsed, stowed position. As noted above, the soft top assembly 12 may be detached from the vehicle 10 and stored, in its collapsed and stowed position, within an integrated soft top storage system 100.

With further reference to FIGS. 2-8, the soft top storage system 100 will be described in accordance with the principles of the present disclosure. In the example implementation, the soft top storage system 100 generally includes a main storage container 102, a first supplemental storage container 200, and a second supplemental storage container 300. The storage containers 100, 200, 300 are formed from a rigid material (e.g., plastic) configured to provide impact and puncture protection to items stored therein. The first and second supplemental storage containers 200, 300 are configured to releasably couple to each other, as well as releasably couple to the main storage container 102.

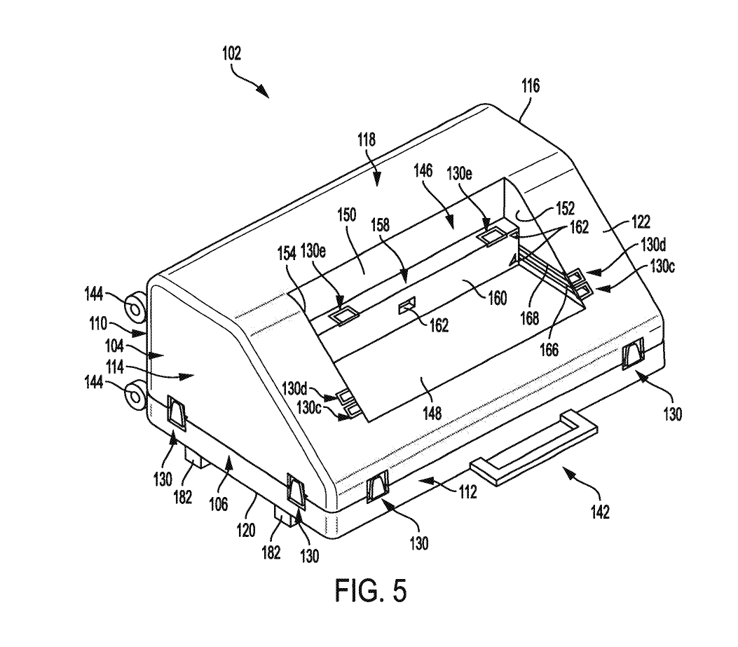

With particular reference to FIGS. 4-6, the main storage container 102 generally includes an upper lid 104 configured to selectively couple to a lower lid 106 for opening and closing the main storage container 102. When in the closed position, shown for example in FIG. 5, the main storage container 102 defines a bottom wall 110, a top wall 112, side walls 114, 116, a front wall 118, a rear wall 120, and an angled front wall 122 extending between the front wall 118 and the top wall 112.

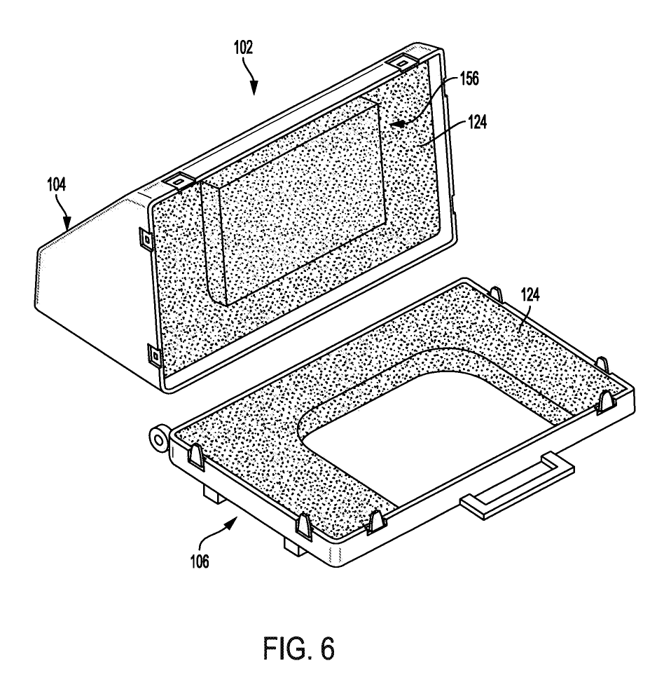

FIG. 6 illustrates the main storage container 102 in an open position and provided with protective inserts 124 (e.g., foam) in both the upper and lower lids 102, 104. The protective inserts 124 are configured to provide a soft, shock-absorbing protective surface for receiving and supporting the articulating frame 50 and main cover 52, as shown in FIG. 4. The protective inserts 124 may include cutouts (not shown) generally shaped like an outline of the articulating frame 50 and main cover 52 to provide a more secure fit therefor.

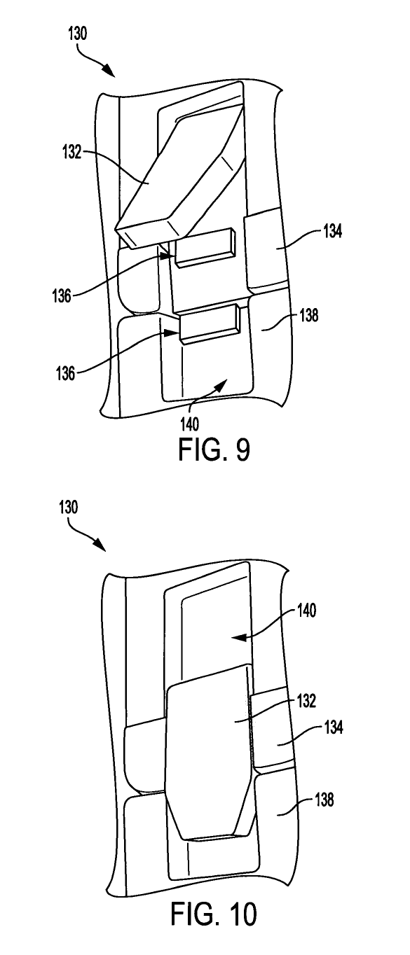

In the example implementation, the upper lid 104 is coupled to the lower lid 106 by a plurality of locking latches 130. As shown in more detail in FIGS. 9 and 10, locking latches 130 may include a clamp or latch 132 pivotally connected to one lid 134 (e.g., upper lid 104), and a locking rib or feature 136 formed on the other lid 138 (e.g., lower lid 106). FIG. 9 illustrates the locking latch 130 in the open position where the latch 132 does not engage the locking feature 136. FIG. 10 illustrates the locking latch 130 in the closed position where the latch 132 engaged the locking feature 136 to couple the first lid 134 to the second lid 138. Moreover, the latch 132 and locking feature 136 may be disposed within a recess 140 formed in the lids 134, 138, such that locking latch 130 does not protrude beyond the surfaces of the first and second lids 134, 138 to provide a flush surface. Although described with locking latch 130, soft top storage system 100 may have any suitable latch or fastener system that enables system 100 to function as described herein.

As shown in FIG. 5, the upper lid 104 is coupled to the lower lid 106 by a pair of locking latches 130 on each of the bottom wall 110, the top wall 112, and the side walls 114, 116. However, it should be understood that any number of locking latches 130 may be used to secure the upper lid 104 to the lower lid 106. For example, the side walls 114, 116 may only include a single locking latch 130 while the bottom and top walls 110, 112 each include two locking latches 130. Moreover, in alternative implementation, the upper lid 104 may be hingedly coupled to the lower lid 106, thereby obviating the need for locking latches 130 on the bottom wall 112. As illustrated, the side walls 114, 116 can include one or more hand recesses 140 formed therein to assist the user to separate the upper and lower lids 102, 104 or to move the main storage container 102.

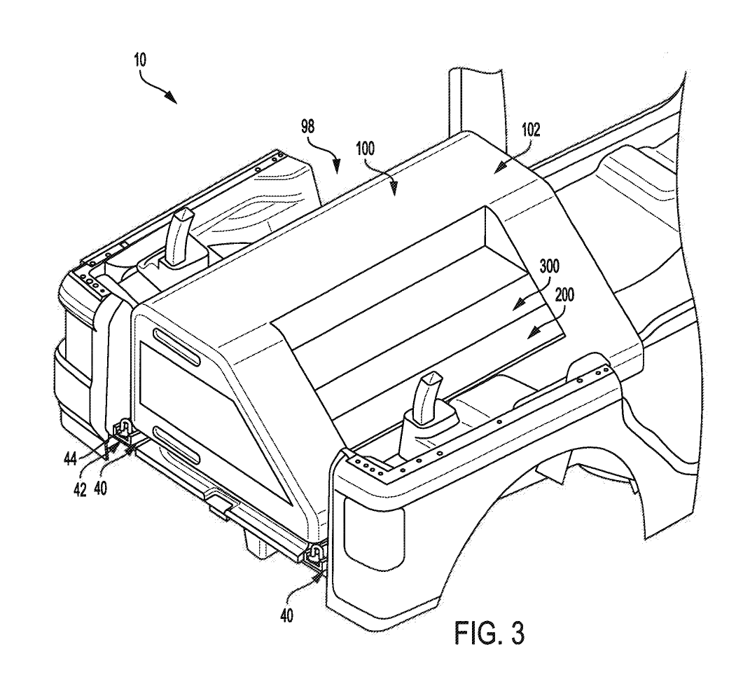

In addition, the top wall 112 includes a handle 142 configured to assist the user in moving the main storage container 102, particularly in and out of the rear cargo area 98 of the vehicle 10 (see FIG. 3). The bottom wall 112 (or any other wall) may include a plurality of rotatable rollers 144 configured to enable the main storage container 102 to be rolled along the ground for easier transport thereof.

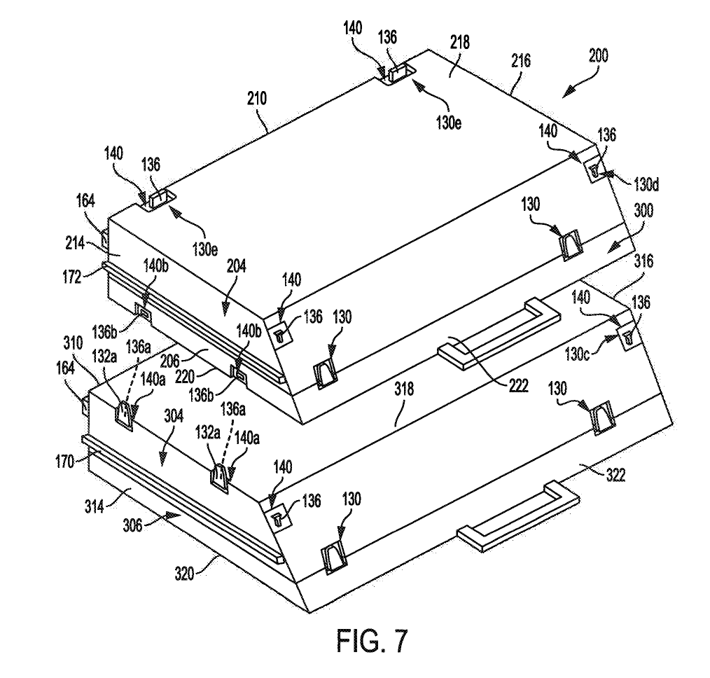

With additional reference to FIGS. 3, 7, and 8, the first supplemental storage container 200 will be discussed in more detail. The first supplemental storage container 200 is configured to store the soft top quarter windows 54 and the rear window 56, and generally includes an upper lid 204 configured to selectively couple to a lower lid 206 for opening and closing the storage container 200. When in the closed position, shown for example in FIG. 7, storage container 200 defines a bottom wall 210, a top wall 212, side walls 214, 216, a front wall 218, a rear wall 220, and an angled front wall 222.

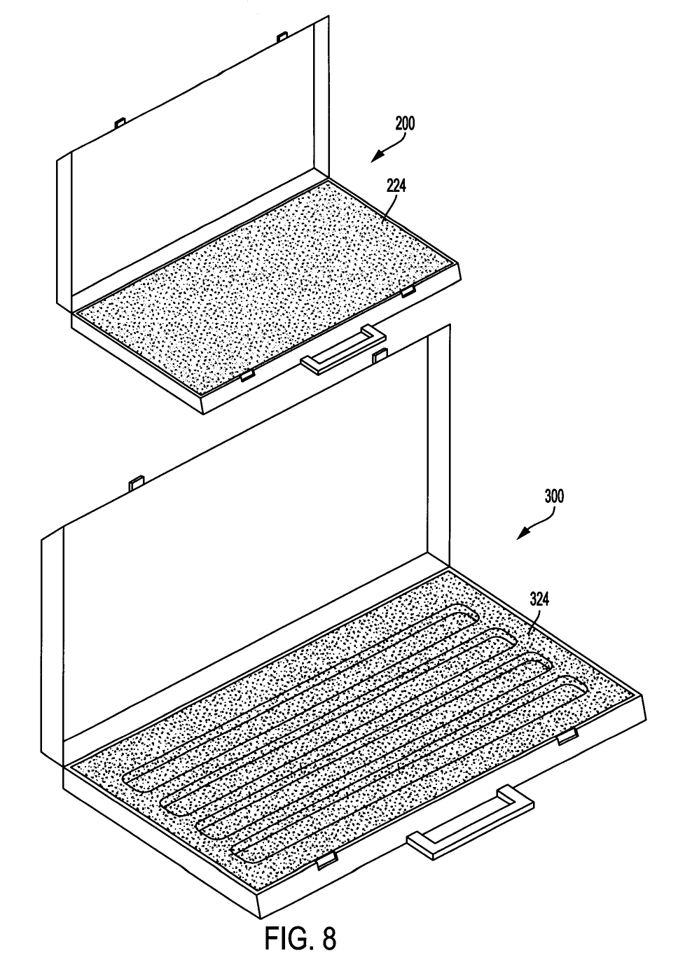

FIG. 8 illustrates the first supplemental storage container 200 in an open position and provided with protective inserts 224 (e.g., foam) in both the upper and lower lids 204, 206 configured to provide added protection to the windows 54, 56. In the example implementation shown in FIGS. 7 and 8, the upper lid 204 is hingedly coupled to the lower lid 206 at bottom wall 210 and is selectively secured thereto by one or more locking latches 130 on the angled front wall 222. In addition, side walls 214, 216 may include one or more features of locking latch 130 to enable the first supplemental storage container 200 to be releasably coupled to the second supplemental storage container 300. For example, as shown in FIG. 7, container 200 may include latch 132a and a first locking feature 136a, and container 300 may include a second locking feature 136b. When containers 200, 300 are separated, latch 132 may be coupled to first locking feature 136a located in a recess 140a on container 200. When it is desired to couple container 200 to container 300, latch 132 may be coupled to the second locking feature 136b located in a recess 140 on container 300.

With continued reference to FIGS. 3, 7, and 8, the second supplemental storage container 300 will be discussed in more detail. The second supplemental storage container 300 is configured to store the door rails 58 and/or any additional components (not shown) of the soft top assembly 12. Container 300 generally includes an upper lid 304 configured to selectively couple to a lower lid 306 for opening and closing the storage container 300. When in the closed position, shown for example in FIG. 7, storage container 30 defines a bottom wall 310, a top wall 312, side walls 314, 316, a front wall 318, a rear wall 320, and an angled front wall 322.

FIG. 8 illustrates the second supplemental storage container 300 in an open position and provided with protective inserts 324 (e.g., foam) in both the upper and lower lids 304, 306 configured to provide added protection to the door rails 58 and/or additional components. In the example implementation, shown in FIGS. 7 and 8, the upper lid 304 is hingedly coupled to the lower lid 306 at bottom wall 310 and is selectively secured thereto by one or more locking latches 130 on the angled front wall 322. As described above, side walls 314, 316 may include one or more features of locking latch 130 to enable the first supplemental storage container 200 to be releasably coupled to the second supplemental storage container 300.

As described herein, the first and second supplemental storage containers 200, 300 are configured to couple to each other. Moreover, containers 200, 300 may be further coupled to the main storage container 102 to form the single unit storage system 100, which will now be described in more detail.

With additional reference to the main storage container 102 shown in FIG. 5, the angled front wall 122 includes a cavity 146 formed therein, which is sized and configured to detachably receive the first and second supplemental storage containers 200, 300 therein. As such, as shown in FIG. 3, the supplemental storage containers 200, 300 can be coupled within the cavity 146 to the main storage container 102 to form a single storage unit 100.

In particular, as shown in FIG. 5, cavity 146 is defined by a rear wall 148, a lower wall 150, and opposed inner side walls 152, 154. The cavity 146 thus defines a clearance or spaces 156 between side wall 114 and the inner side wall 152, as well as between side wall 116 and inner side wall 154, which is configured to receive portions of the articulating frame 50, as illustrated in FIG. 4.

A ledge 158 is located within the cavity 146 and includes a surface 160 to receive the first and second supplemental storage containers 200, 300 when they are secured to the main storage container 102. In one example implementation, surface 160 includes recessed locating features 162 that are configured to matingly receive projections 164 formed on the first and second supplemental storage containers 200, 300, which facilitates orientation and locking between the storage containers 200, 300 and the main storage container 102.

Alternatively, or additionally, as shown in FIG. 5, the inner side walls 152, 154 may each include opposed first channels 166 and opposed second channels 168 formed therein. The first channels 166 are each configured to receive a rail or rib 170 formed on the first supplemental storage container 200, and the second channels 168 are each configured to receive a rail or rib 172 formed on the second supplemental storage container 300. As such, the rails 170 of the first supplemental storage container 200 can be slid into the first channels 166 such that container 200 is precisely located within cavity 146 as the container is moved toward the ledge 158 where the projections 164 are received in the recess features 162 to locate container 200 in a final position for coupling to the main storage container 102. Similarly, the rails 172 of the second supplemental storage container 300 are received in the second channels 168 to locate container 300 within the cavity 146.

Once in the position shown in FIG. 3, the first supplemental storage container 200 may be coupled to the main storage container 102 by locking latches 130c extending between the angled front wall 122 and the angled front wall 222. Similarly, once in the position shown in FIG. 3, the second supplemental storage container 300 may be coupled to the main storage container 102 by locking latches 130d extending between the angled front wall 122 and the angled front wall 322, and/or by locking latches 130e extending between the ledge 158 and the front wall 218.

In addition, as shown in FIGS. 2-4, soft top storage system 100 is configured to detachably couple to the vehicle rear cargo area 98. In one example implementation shown in FIG. 2, rear cargo area 98 includes built in floor channels 40 which can receive tie down devices 42. The tie down devices 42 can slide along floor channels 40 to a desired position and include a hook or loop 44 to couple to one or more ropes 99 for securing the soft top storage system 100 to the floor of the rear cargo area 98. However, it should be understood that tie down devices 42 may include any suitable connecting or coupling feature 44 that facilitates securing the soft top storage system 100 within the rear cargo area 98.

In another example implementation, main storage container 102 may include apertures or recesses (not shown) formed in rear wall 120 configured to receive tie down devices 42 therein. As such, tie down devices 42 may be inserted into floor channels 40, and storage container 102 is oriented over the tie down devices 42 such that the tie down devices 42 are received within the recesses formed in the rear wall 120. In yet another implementation, main storage container 102 may include tie down devices 42 integrally formed in rear wall 120 and configured to be received by floor channels 40. In yet another implementation, main storage container may include one or more attachment features 182 (FIG. 5) formed on an outer wall (e.g., rear wall 120) that are configured to couple to a portion of the rear cargo area 98 (e.g., the rear cargo area floor), to thereby secure the main storage container 102 (and thus storage system 100) within the rear cargo area 98. For example, attachment feature 182 may be a projection configured to attach to or fit within a recess (not shown) formed in the rear cargo area floor. In another example, the attachment feature 182 may be rear wall 120, which can fit within a recess or depression (not shown) formed in the rear cargo area floor and sized and configured to receive the rear wall 120 therein. The main storage container 102 may additionally, or alternatively, be releasably coupled by one or more locking latches 130 to the rear cargo area such as, for example, the rear cargo area floor.

Described herein are systems and methods for storing a soft top assembly that has been removed from a vehicle. The storage system includes a main storage container and two supplemental storage containers made from a rigid material. The main storage container is configured to store a frame and cover of the soft top assembly, the and the two supplemental storage containers are configured to respectively store the soft top windows and door rails/other components. For storage and movement convenience, the two supplemental storage containers may be coupled to each other, as well as coupled to the main storage container, to form a single, unitary storage unit.

It will be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A storage system for a removable soft top assembly for a vehicle, the storage system comprising:
a main storage container having a top lid coupleable to a bottom lid, the main storage container sized and shaped to receive and store an articulating frame and main cover of the soft top assembly;
a first supplemental storage container having a top lid coupleable to a bottom lid, the first supplemental storage container sized and shaped to receive and store windows of the soft stop assembly; and
a second supplemental storage container having a top lid coupleable to a bottom lid, the second supplemental storage container sized and shaped to receive and store door rails of the soft top assembly;
wherein the second supplemental storage container is selectively coupleable to the first supplemental storage,
wherein the first and second supplemental storage containers are selectively coupleable to the main storage container, and
wherein the storage system is adapted to be received in and removably secured to a rear cargo area of the vehicle.

2. The storage system of claim 1, wherein the main storage container includes a cavity formed therein, the cavity configured to receive the first and second supplemental storage containers.

3. The storage system of claim 2, wherein the cavity is formed in an angled front wall of the main storage container.

4. The storage system of claim 3, wherein the cavity includes a ledge configured to receive the first and second supplemental storage containers.

5. The storage system of claim 3, wherein the first supplemental storage container is coupled to the angled front wall of the main storage container by at least one locking latch.

6. The storage system of claim 3, wherein the second supplemental storage container is coupled to the angled front wall of the main storage container by at least one locking latch.

7. The storage system of claim 4, wherein the second supplemental storage container is coupled to the ledge by at least one locking latch.

8. The storage system of claim 1, wherein the main storage container, the first supplemental storage container, and the second supplemental storage container are fabricated from a rigid material.

9. The storage system of claim 1, wherein the main storage container includes a bottom wall having a plurality of rollers configured to enable the main storage container to roll across the ground.

10. A vehicle comprising:
a rear cargo area;
a soft top assembly removably coupled to the vehicle, the soft top assembly having an articulating frame, a main cover, windows, and door rails; and
a soft top storage system configured to removably couple to the rear cargo area of the vehicle, the soft top storage system configured to receive and store the articulating frame, the main cover, the windows, and the door rails.

11. The vehicle of claim 10, wherein the storage system comprises:
a main storage container having a top lid coupleable to a bottom lid, the main storage container sized and shaped to receive and store the articulating frame and the main cover of the soft top assembly;
a first supplemental storage container having a top lid coupleable to a bottom lid, the first supplemental storage container sized and shaped to receive and store the windows of the soft stop assembly;
a second supplemental storage container having a top lid coupleable to a bottom lid, the second supplemental storage container sized and shaped to receive and store the door rails of the soft top assembly;
wherein the second supplemental storage container is selectively coupleable to the first supplemental storage; and
wherein the first and second supplemental storage containers are selectively coupleable to the main storage container.

12. The vehicle of claim 11, wherein the rear cargo area includes a floor having channels formed therein, the channels configured to receive tie down devices configured to facilitate securing the soft top storage system to the rear cargo area floor.

13. The vehicle of claim 11, wherein the rear cargo area includes a floor, and the main storage container is removably coupled to the floor by at least one locking latch.

14. The vehicle of claim 11, wherein the main storage container includes a cavity formed therein, the cavity configured to receive the first and second supplemental storage containers.

15. The vehicle of claim 14, wherein the cavity is formed in an angled front wall of the main storage container.

16. The vehicle of claim 15, wherein the cavity includes a ledge configured to receive the first and second supplemental storage containers.
